(19) United States
(12) Patent Application Publication
(10) Pub. No.: US 2020/0329715 A1
(43) Pub. Date: Oct. 22, 2020

(54) CATMINT OIL REPELLENT AGAINST MOSQUITOS

(71) Applicant: ENTOMOL PRODUCTS, LLC, San Francisco, CA (US)

(72) Inventors: JOHN RICHARD INGS, O'Connor (AU); PETRUS VAN BRUINSESSEN, Shoalhaven Heads (AU)

(73) Assignee: ENTOMOL PRODUCTS, LLC, San Francisco, CA (US)

(21) Appl. No.: 16/852,025

(22) Filed: Apr. 17, 2020

Related U.S. Application Data
(60) Provisional application No. 62/835,732, filed on Apr. 18, 2019.

(51) Int. Cl. A01N 65/22; A01N 25/04

(52) U.S. Cl. CPC A01N 65/22; A01N 25/04

(57) ABSTRACT

The invention relates to spatial hydrogenated catmint oil insect formulations and methods of spatially administering the formulations to deter and repel insects from biting, stinging or landing on a human or animal host(s). The formulations are water based and include the hydrogenated catmint oil as an active ingredient or component, as well as an emulsifying agent. The formulations are administered by dispersing, e.g., vaporizing, into the atmosphere that is in proximity to the host(s). The formulations and methods of the invention are effective to deter or repel insects absent of any deterrent or repellent formulation applied to the skin of the host(s).

### CROSS-REFERENCE TO RELATED APPLICATIONS

This application claims priority from U.S. Provisional Patent Application Ser. No. 62/835,732, entitled “CATMINT OIL REPELLENT AGAINST MOSQUITOS”, filed on Apr. 18, 2019, the disclosure of which is incorporated herein by reference.

### FIELD OF THE INVENTION

The invention generally relates to hydrogenated catmint oil (HCO) insect repellent formulations, as well as methods and uses to deter and repel insects, such as, mosquitos. More particularly, the invention includes spatial HCO formulations that are dispersed or vaporized into the atmosphere to effectively deter and repel mosquito Aedes aegypti.

### BACKGROUND

Hydrogenated catmint oil (HCO) is a nature-based insect repellent ingredient derived from a catmint (Nepeta cataria) plant. Repellent substances, e.g., formulations, generally cause insects to be driven away from or to reject otherwise insect-acceptable food sources or habitats. In general, a process is used to obtain or extract the essential oil from the Nepeta cataria plant, which is referred to as “catmint oil”. It is known to topically/dermally apply HCO repellent formulations directly to human skin in an appropriate, e.g., therapeutically acceptable, amount or dosage. In these applications, HCO repellent formulations have been demonstrated to be effective for several hours or more in deterring insects, such as, mosquitoes, that can transmit diseases including yellow fever and malaria. There are disadvantages associated with applying repellent formulations directly to the skin, such as but not limited to, an uncomfortable residue on the surface of the skin, a likelihood of being easily removed by materials or substances, e.g., clothing or water, that contact the skin, and an uncertainty as to the dosage based on the amount applied to the skin.

Thus, there is a need in the art to protect humans from mosquito bites and the effects therefrom, without requiring a repellent formulation to be directly applied to the skin. Therefore, the invention provides a safe, effective and more convenient method of protection from the unhealthy effects of insects, such as mosquitos.

### SUMMARY OF THE INVENTION

In one aspect, the invention provides a method of deterring or repelling insect bites or stings on a human or animal host. The method includes obtaining formulation components, including from about 0.001% to about 5.0% of hydrogenated catmint oil; from about 0.001% to about 5.0% of an emulsifying agent; and a remainder of water by volume; combining the hydrogenated catmint oil, emulsifying agent and water to form a spatial formulation; obtaining at least one ultrasonic dispersion apparatus; placing the spatial formulation in the apparatus; setting the apparatus in an area; and activating the apparatus to disperse the spatial formulation into atmosphere of the area to deter or repel insects, wherein the method excludes applying the insect deterrent or repellent formulation to the skin of the human or animal host.

In certain embodiments, the hydrogenated catmint oil constitutes from about 0.01% to about 5.0% by volume, or from about 0.10% to about 5.0% by volume, or from about 0.10% to about 1.0% by volume, or from about 0.05% to about 0.1% by volume.

Similarly, the emulsifying agent may constitute from about 0.01% to about 5.0% by volume, or from about 0.10% to about 1.0% by volume, or from about 0.05% to about 0.1% by volume.

In certain embodiments, the formulation components constitute about 0.1% of hydrogenated catmint oil, about 0.1% of emulsifying agent and about 99.8% of water, by volume.

The method may include one or more vaporizers as the ultrasonic dispersion apparatus.

In certain embodiments, the rate of dispersion of the spatial formulation by each of the ultrasonic dispersion apparatus is from about 125 ml/hour to about 250 ml/hour.

In another aspect, the invention provides a method of administering an insect deterrent or repellent formulation to a human or animal host. The method includes obtaining formulation components, including from about 0.001% to about 5.0% of hydrogenated catmint oil; from 0.001% to about 5.0% of an emulsifying agent; and a remainder of water by volume; combining the hydrogenated catmint oil, emulsifying agent and water to form a spatial formulation; obtaining at least one ultrasonic dispersion apparatus; placing the spatial formulation in the apparatus; setting the apparatus in proximity of the host; and activating the apparatus to disperse the spatial formulation into an atmosphere in proximity of the host, wherein the method excludes applying the insect deterrent or repellent formulation to the skin of the human or animal host.

In still another aspect, the invention provides a spatial insect deterrent or repellent formulation that includes from about 0.001% to about 5.0% of hydrogenated catmint oil; from 0.001% to about 5.0% of an emulsifying agent; and a remainder of water by volume.

### BRIEF DESCRIPTION OF THE DRAWINGS

A full understanding of the disclosed concept can be gained from the following description of the preferred embodiments when read in conjunction with the accompanying drawings:

FIG. 1 is a photograph of the room set-up for conducting the catmint repellency experimental trials, in accordance with the invention;

FIG. 2 is a photograph of each of the vaporizer and the tambourine mosquito exposure cage used in conducting the catmint repellency experimental trials, in accordance with the invention;

FIG. 3 is a plot of catmint repellency for a HCO formulation tested in experimental trials, in accordance with the invention;

FIG. 4 is a plot of mean landing rates for experimental trials including various HCO formulation trials, a PMD formulation trial and control trials, in accordance with the invention; and

FIG. 5 is a plot of repellency for experimental trials including various HCO formulation trials, a PMD formulation trial and control trials, in accordance with the invention.

### DETAILED DESCRIPTION OF PREFERRED EMBODIMENTS

The invention is directed to spatial insect deterrent and/or repellent formulations and compositions that include an effective amount of hydrogenated catmint oil (HCO) as active ingredient or component, along with other components and/or additives, as well as methods for spatially administering or distributing the formulations and compositions to deter and/or repel insects, such as mosquitos, e.g., mosquito Aedes aegypti, from biting, stinging and/or landing on the skin of a human or animal host, and mitigating the effects of an insect, e.g., mosquito, bite or sting. The formulations and compositions are water-based and therefore, include water in addition to the HCO active ingredient/component, as well as emulsifiers or emulsifying agents and the like. The formulations and compositions are administered by dispersing, e.g., vaporizing, into an atmosphere using an appropriate dispersing apparatus. Suitable apparatus for dispersion include a wide variety of ultrasonic devices of various outputs that are known in the art. One or more apparatus is/are typically positioned in a location that is in close proximity to the host(s). The formulations, compositions and methods of the invention are effective to deter or repel insects in the absence of any deterrent or repellent formulation applied to the skin of the host(s).

For ease of description, the disclosure is primarily directed to mosquitos and human host(s). However, it is understood and contemplated that the invention is not limited to the description relating to mosquitos and human skin. For example, the formulations, compositions and methods of the invention encompass a variety of insects, and insect bites and stings, other than mosquitos, and are suitable for administration and distribution to subjects other than human, such as, animal.

The inventors have surprisingly found that topical/dermal application of HCO formulations directly to human skin is not necessary in order to deter and repel mosquitos. More particularly, spatial HCO formulations dispersed, e.g., vaporized, into an atmosphere, e.g., air, have been demonstrated to be effective for several hours or more in deterring and repelling insects, such as, mosquito Aedes aegypti.

The spatial repellent formulations are water-based solutions that include an HCO active ingredient and an emulsifier/emulsifying agent (in addition to the water). The HCO is derived from essential oil of the catmint plant Nepeta cateria. The essential oil is treated or processed to produce catmint oil employing various treatments or processes known in the art, such as distillation and/or treatment with an oxidizing agent. The catmint oil is used in a hydrogenation reaction to produce the HCO. The hydrogenation reaction includes the use of hydrogen and a hydrogenation catalyst to produce the HCO hydrogenated product.

Suitable emulsifying agents for use in the invention include a wide variety of emulsifiers, stabilizers and surfactants known in the art, such as but not limited to polysorbate nonionic surfactants. In certain embodiments, the formulation includes a polysorbate nonionic surfactant which is commercially available under the tradename TWEEN® 20 (from Sigma Aldrich) or POLYSORBATE 20. The emulsifier prevents separation of the liquid components in the formulations.

The amount of HCO, emulsifying agent, and water in the formulations varies within a range for each component. The HCO constitutes from about 0.001% to about 5.0% or from about 0.01% to about 5.0% or from about 0.10% to about 5.0% or from about 0.10% to about 1.0% by volume. In certain embodiments, HCO is present in an amount from about 0.05% to about 0.1% by volume. The emulsifying agent constitutes from about 0.001% to about 5.0% or from about 0.01% to about 5.0% or from about 0.10% to about 5.0% or from about 0.10% to about 1.0% by volume. In certain embodiments, emulsifying agent is present in an amount from about 0.05% to about 0.1% by volume. The water constitutes the remainder of the formulation by volume. In certain embodiments, the spatial repellent formulation is composed of about 0.1% of HCO, about 0.1% of emulsifying agent and 99.8% of water, by volume of formulation.

The HCO, emulsifying agent and water in selected amounts are combined together to form the HCO formulation. The order of addition of these components is not limiting. The formulation is then placed in an apparatus to administer or disperse, e.g., vaporize, the spatial HCO formulation into the atmosphere. There are a wide variety of dispersion apparatus known in the art for use in the invention, such as but not limited to ultrasonic devices of various outputs, e.g., vaporizers.

The dispersion apparatus holding the spatial HCO formulation is activated to dispense and disperse, e.g., vaporize, the formulation into the atmosphere of a space or area, e.g., one or more rooms. Typically, the dispersion apparatus is located inside the space or area wherein the HCO formulation is to be dispersed. However, it is suitable for the dispersion apparatus to be located external to the space or area, wherein there is an opening or vent into the space or area such that the HCO formulation is dispersed through the opening or vent into the atmosphere of the space or area. In certain embodiments, the dispersion apparatus is portable and transportable from one space or area to another. It is contemplated and understood that the amount or volume of each component in the spatial HCO formulation varies based on use of larger volumes and the selected ultrasonic device to disperse or vaporize the formulation. Further, the amount or volume of the HCO formulation used is dependent upon one or more of the features, e.g., size and robustness, of the dispersion apparatus, size of the space or area, size of the atmosphere (e.g., a confined or open space/area), population or amount of the mosquitos, and population or amount of the hosts. In certain embodiments, the atmosphere is a contained, confined, defined or restricted atmosphere, such as a particular room or rooms, e.g., an interior space of a commercial or domestic building, e.g., an office or a house, respectively. Furthermore, the number of dispersion apparatus employed also depends on these factors. For example, the size of the space/area and the ability to contain the atmosphere of the space/area, such as whether the space is a closed, interior space or an open and/or exterior space, as well as the number of hosts, e.g., people, located within the space/area, determines if one or more than one ultrasonic device is employed to disperse the HCO formulation.

The rate of dispersion of the HCO formulation also varies depending on the selected dispersion apparatus, and the setting on which the apparatus is activated. In certain embodiments, the rate of dispersion of the HCO formulation by each dispersion apparatus is from 125 ml/hour to 250 ml/hour

In certain embodiments, a fan (e.g., pedestal of ceiling fan) or like apparatus is placed inside the space or area containing the ultrasonic dispersion device, and activated on a low to medium setting to facilitate dispersal of the HCO formulation in the atmosphere.

Moreover, as aforementioned, the spatial HCO formulation is spatially administered to the host(s), and excludes the use or combination of insect deterrent or repellent formulations applied to the skin of the host(s). The one or more dispersion apparatus that administer the spatial HCO formulation is typically located in proximity to, near, or in close proximity to, the host(s). In certain embodiments, the host(s) and the one or more dispersion apparatus are located and positioned within the same space/area, wherein the space/area is open (e.g., an outside environment) or confined (e.g., an inside environment). As a non-limiting example, the host(s) is located inside of a confined space or area, e.g., structure formed by barriers or walls, such as a commercial building or domestic room(s), with the apparatus that is dispersing the HCO formulation into the atmosphere being positioned inside of the space/area.

While the invention has been described in terms of various specific embodiments, those skilled in the art will recognize that the invention can be practiced with modifications within the spirit and scope of the description and following examples/experiments.

### EXAMPLES

### Example 1

The trials described below were conducted to demonstrate the effectivity of spatial HCO formulations to repel free flying female mosquito Aedes aegypti (“mosquitos”) within a domestic setting. Essential oil treatments including water-based solutions with HCO active ingredient were tested, as well as control samples absent of the HCO active ingredient.

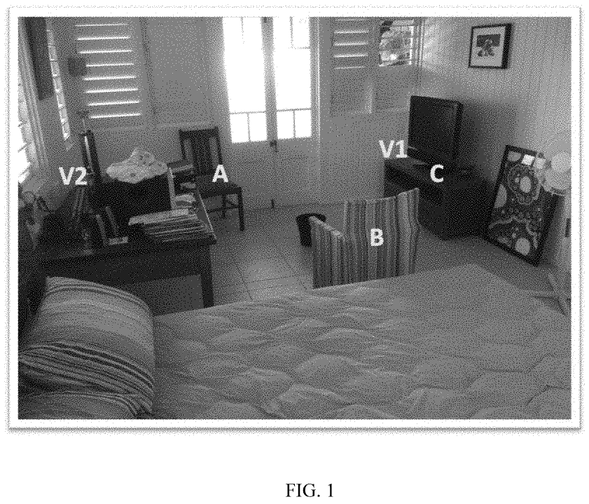

The experimental room was a bedroom having a cubic area of 50 m³, within a Queenslander style house in Cairns QLD. Within the bedroom were released 30-40 female mosquitos. All windows and doors in the bedroom were closed to prevent escape of any of the mosquitos. Three human subjects, e.g., hosts, conducted a human landing rate (LR) count. Each of the subjects, having both of its lower legs exposed, entered the bedroom and remained inside for five minutes prior to dispersion of the HCO formulation. During this period, the LR count for each subject was recorded as the pre-treatment count. Subsequently, at least one vaporizer was placed in the bedroom and activated to disperse the HCO formulation into the atmosphere. The human subjects then entered the bedroom, and a LR count for each subject was recorded at 5-, 20- and 60-minute time periods, which represented the post-treatment counts. As shown in FIG. 1, the human subjects were located in the positions marked A, B and C. This procedure was repeated for multiple trials employing different HCO formulations, a PMD formulation and a control formulation.

The vaporizer (Znufashion in Sydney, Model GYJ-105, 1500 ml, Steam Aroma Perfume Ultrasonic Air Humidifier Diffuser Purifier Mist 1.5L, made in China) was positioned in a corner of the bedroom, shown in FIG. 1 as V1, and activated by the “on” switch. Since the outside temperature was cool at below 20° C., which is known to impede mosquito biting, a small portable space heater was also placed inside the bedroom and activated to raise the temperature to 24-26° C. In addition, a pedestal fan was placed inside the bedroom and activated on a “low” setting to contribute to ventilation and dispersal of the HCO formulation.

For the post-treatment trials, HCO formulations and a PMD formulation were used as described below:
1. Formulation 1 (replicate A): 0.1% HCO (active), 0.1% Tween 20 (emulsifier), and 99.8% water;
   Situation: 2 machines/vaporizers, 250 ml per hr;
2. Formulation 2 (replicate B): 0.1% HCO (active), 0.1% Tween 20 (emulsifier), and 99.8% water;
   Situation: 2 machines/vaporizers, 250 ml per hr;
3. Formulation 3: 0.1% HCO (active), 0.1% Tween 20 (emulsifier), and 99.8% water;
   Situation: 1 machine/vaporizer, 125 ml per hr;
4. Formulation 4: 0.05% HCO (active), 0.1% Tween 20 (emulsifier), and 99.8% water;
   Situation: 1 machine/vaporizer, 125 ml per hr; and
5. Formulation 5: 0.1% PMD (active-oil of eucalyptus-industry standard), 0.1% Tween 20 (emulsifier), and 99.8% water;
   Situation: 1 machine/vaporizer, 125 ml per hr.

In addition to the active ingredient/component, all of the above formulations (referred to as HCO formulation 1, HCO formulation 2, HCO formulation 3, HCO formulation 4 and PMD formulation 5, respectively) included 0.1% TWEEN as emulsifier and 99.8% water. As indicated above, the essential oil of HCO was tested employing one machine and two machines for dispersion. Each of the PMD and TWEEN 20 were dispersed using only one machine.

Further, for the LR count, control trials were conducted including a no treatment, trial (referred to as control 1) and a control formulation (referred to as control formulation 2) used as described below:
1. No treatment; no vaporizer (negative control); and
2. 0.1% TWEEN-20 active; one machine; 125 ml per hr (emulsifier control).

In addition to TWEEN-20, control 2 included 99.9% water.

Based on LR counts for the pre-treatment and post-treatment trials, percent repellency was measured by the percentage reduction from the pre-treatment LR count to each of the post-treatment LR counts.

The data for the pre-treatment and post treatment trials with the three human subjects, i.e., S1, S2 and S3, is shown in Tables 1 through 7.

The data for HCO formulation 1 (replicate A) for S1, S2, and S3 is shown below in Table 1.

TABLE 1

| | | | | | | |
|---|---|---|---|---|---|---|
| Time | Bites S1 | Bites S2 | Bites S3 | Total Bites | Mean | Repell % |

PRE-TREATMENT

| | | | | | |
|---|---|---|---|---|---|
| 5 mins | 54 | 23 | 19 | 96 | 32.0 |

POST-TREATMENT

| | | | | | | |
|---|---|---|---|---|---|---|
| 5 mins | 5 | 5 | 12 | 22 | 7.3 | 77.1% |
| 20 mins | 9 | 0 | 10 | 19 | 6.3 | 80.2% |
| 60 mins | 0 | 0 | 1 | 1 | 0.3 | 99.0% |

The data for HCO formulation 2 (B replicate) is shown below in Table 2.

TABLE 2

| | | | | | | |
|---|---|---|---|---|---|---|
| Time | Bites S1 | Bites S2 | Bites S3 | Total Bites | Mean | Repell % |

PRE-TREATMENT

| | | | | | |
|---|---|---|---|---|---|
| 5 mins | 42 | 32 | 49 | 123 | 41.0 |

POST-TREATMENT

| | | | | | | |
|---|---|---|---|---|---|---|
| 5 mins | 1 | 1 | 36 | 38 | 12.7 | 69.1% |
| 20 mins | 0 | 0 | 1 | 1 | 0.3 | 99.2% |
| 60 mins | 0 | 0 | 24 | 24 | 8.0 | 80.5% |

The data for HCO formulation 3 is shown below in Table 3.

TABLE 3

| | | | | | | |
|---|---|---|---|---|---|---|
| Time | Bites S1 | Bites S2 | Bites S3 | Total Bites | Mean | Repell % |

PRE-TREATMENT

| | | | | | |
|---|---|---|---|---|---|
| 5 mins | 30 | 25 | 8 | 63 | 21.0 |

POST-TREATMENT

| | | | | | | |
|---|---|---|---|---|---|---|
| 5 mins | 6 | 4 | 3 | 13 | 4.3 | 79.4% |
| 20 mins | 3 | 0 | 1 | 4 | 1.3 | 93.7% |
| 60 mins | 3 | 1 | 1 | 5 | 1.7 | 92.1% |

The data for HCO formulation 4 is shown below in Table 4.

TABLE 4

| | | | | | | |
|---|---|---|---|---|---|---|
| Time | Bites S1 | Bites S2 | Bites S3 | Total Bites | Mean | Repell % |

PRE-TREATMENT

| | | | | | |
|---|---|---|---|---|---|
| 5 mins | 60 | 17 | 50 | 127 | 42.3.0 |

POST-TREATMENT

| | | | | | | |
|---|---|---|---|---|---|---|
| 5 mins | 21 | 0 | 7 | 28 | 9.3 | 78.0% |
| 20 mins | 20 | 0 | 10 | 30 | 10.0 | 76.4% |
| 60 mins | 5 | 0 | 12 | 17 | 5.7 | 86.6% |

The data for PDM formulation 5 is shown below in Table 5.

TABLE 5

| | | | | | | |
|---|---|---|---|---|---|---|
| Time | Bites S1 | Bites S2 | Bites S3 | Total Bites | Mean | Repell % |

PRE-TREATMENT

| | | | | | |
|---|---|---|---|---|---|
| 5 mins | 43 | 24 | 31 | 98 | 32.7 |

POST-TREATMENT

| | | | | | | |
|---|---|---|---|---|---|---|
| 5 mins | 29 | 1 | 17 | 47 | 15.7 | 52.0% |
| 20 mins | 18 | 1 | 21 | 40 | 13.3 | 59.2% |
| 60 mins | 31 | 0 | 7 | 38 | 12.7 | 61.2% |

The data for the no treatment control 1 is shown below in Table 6.

TABLE 6

| | | | | | | |
|---|---|---|---|---|---|---|
| Time | Bites S1 | Bites S2 | Bites S3 | Total Bites | Mean | Repell % |

PRE-TREATMENT

| | | | | | |
|---|---|---|---|---|---|
| 5 mins | 35 | 0 | 11 | 46 | 15.3 |

TREATMENT

| | | | | | | |
|---|---|---|---|---|---|---|
| 5 mins | 55 | 0 | 7 | 62 | 20.7 | −34.8% |
| 20 mins | 47 | 0 | 9 | 56 | 18.7 | −21.7% |
| 60 mins | 39 | 20 | 9 | 68 | 22.7 | −47.8% |

The data for control formulation 2 is shown below in Table 7.

TABLE 7

| | | | | | | |
|---|---|---|---|---|---|---|
| Time | Bites S1 | Bites S2 | Bites S3 | Total Bites | Mean | Repell % |

PRE-TREATMENT

| | | | | | |
|---|---|---|---|---|---|
| 5 mins | 25 | 2 | 24 | 51 | 17.0 |

TREATMENT

| | | | | | | |
|---|---|---|---|---|---|---|
| 5 mins | 27 | 11 | 24 | 62 | 20.7 | −21.6% |
| 20 mins | 31 | 8 | 37 | 76 | 25.3 | −49.0% |
| 60 mins | 18 | 3 | 50 | 71 | 23.7 | −39.2% |

Visual observations of the mosquitoes during the trials indicated that most of the female mosquitoes exposed to an HCO formulation rapidly ceased host seeking behavior. They did not become agitated and fly about the room. Instead, they sought resting sites such as under tables and beds, as well as on walls and dark objects on the table. However, in some instances, one or two persistent mosquitoes continued to land on a host and attempt to bite, with landings greater than 10 recorded in the period of one minute to two minutes. For example, in HCO formulation 2 (replicate B), subject S3 had an LR of 24 at 60 minutes exposure as compared to subjects S1 and S2 that both had an LR of 0 at 60 minutes. The majority of the 24 landings for S3 represented repeated landings by a single mosquito.

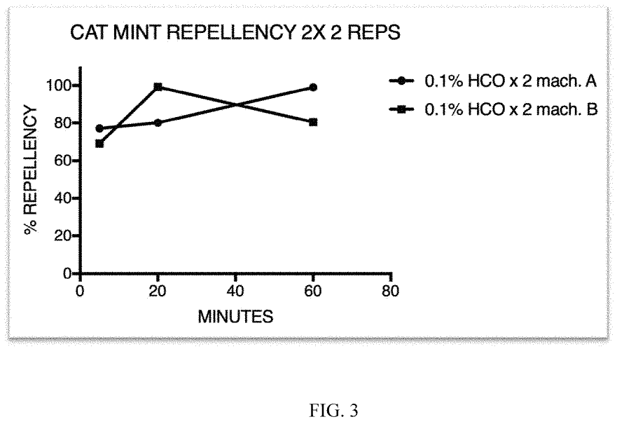

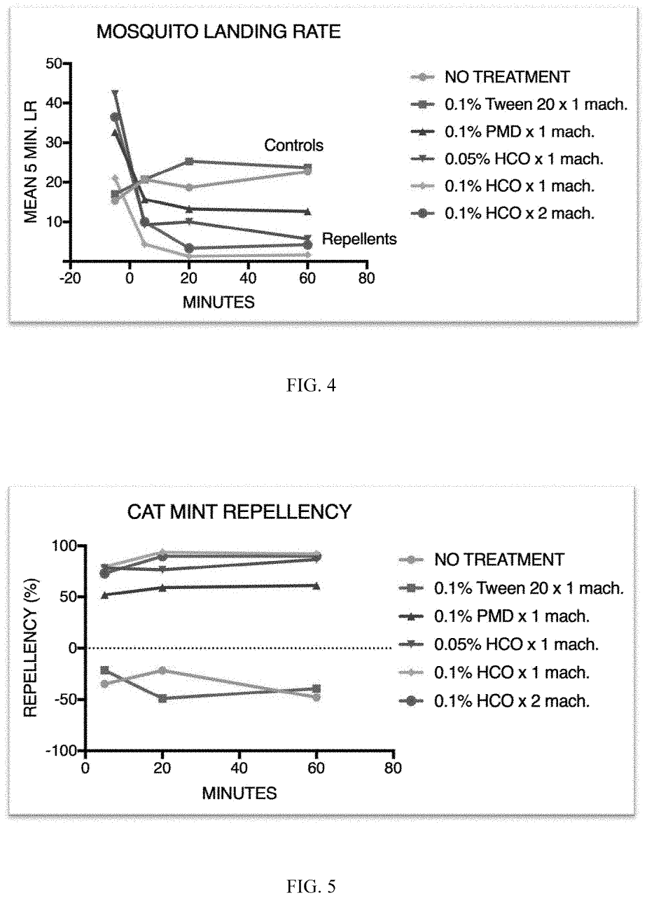

A plot of the percent repellency for each of HCO formulations 1 and 2 (replicates A and B, respectively) is shown in FIG. 3. A plot of the mean LR for each of HCO formulations 1, 2, 3 and 4, PDM formulation 5, no treatment control 1 and TWEEN control 2 is shown in FIG. 4. A significant reduction of biting was observed in all HCO formulations within five minutes. All HCO formulations performed better than the PMD formulation. In FIG. 4, the data for replicates A and B was combined and the corresponding plotted curve represents average values of the two replications. The catmint percentage repellency data for each of HCO formulations 1, 2, 3 and 4, PDM formulation 5, no treatment control 1 and TWEEN control 2 is shown in FIG. 5. The data for replicates A and B was combined and the corresponding plotted curve in FIG. 5 represents average values of the two replications.

The results show a consistent and rapid reduction in mosquito biting rates for all formulations of HCO, i.e., HCO formulations 1-4. The deterrence and repellency impact were greater than the single-dose of PMD, i.e., PDM formulation 5, which is an industry standard. The results for the negative controls using no machine/no treatment and the TWEEN-20 emulsifier control formulation 2 showed no evidence of repellency, which indicated that repellency of the treatments was due to the active ingredient/component in HCO formulations 1, 2, 3 and 4.

### Example 2

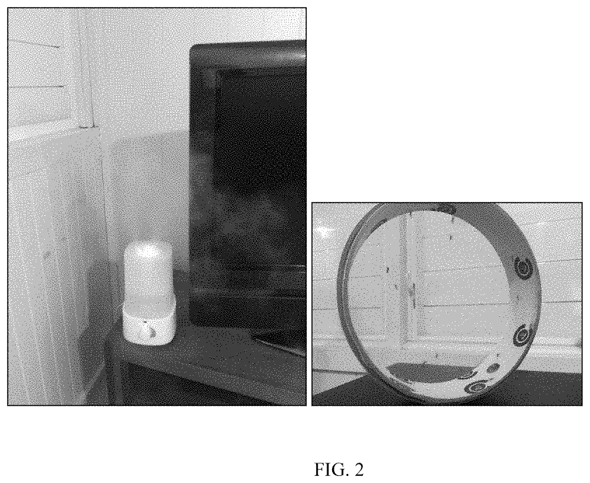

Trials were conducted 24 hours post-treatment to measure the knockdown (KD) of mosquitos exposed to a spatial HCO formulation. Two tambourine-style mesh cages were placed in the bedroom described in FIG. 1, next to the LR station (V1) and in a far corner of the bedroom approximately 2 m from V1. Each cage contained 10-15 male Ae. aegypti (“mosquitos”). The mosquitos were exposed to HCO formulation 2 using the same vaporizers in Example 1. FIG. 2 is a photograph that shows the vaporizer and tambourine mosquito exposure cage used in conducting these trials. The KDs were recorded at 10 minutes, 30 minutes and 60 minutes. No knockdown of the caged mosquitos was observed after 60 minutes of exposure to HCO formulation 2. One cage was then directly exposed to a vapor plume of HCO formulation 2, and some KDs were observed. It appeared that as the mosquitos became saturated by the mist, they were unable to fly. After 24 hours, mortality of the mosquitos was minimal with 0 and 10% KD, the latter in mosquitos saturated the day before.

The low KD rates for the cage exposed-mosquitoes indicated that there was little toxicity of the HCO to the mosquitoes.

We claim:

1. A method of deterring or repelling insect bites or stings on a human or animal host, comprising:
obtaining formulation components, comprising:
from about 0.001% to about 5.0% of hydrogenated catmint oil;
from about 0.001% to about 5.0% of an emulsifying agent; and
a remainder of water by volume;
combining the hydrogenated catmint oil, emulsifying agent and water to form a spatial formulation;
obtaining at least one ultrasonic dispersion apparatus;
placing the spatial formulation in the apparatus;
setting the apparatus in an area; and
activating the apparatus to disperse the spatial formulation into an atmosphere of the area to deter or repel insects,
wherein the method excludes applying the insect deterrent or repellent formulation to the skin of the human or animal host.

2. The method of claim 1, wherein the hydrogenated catmint oil constitutes from about 0.01 to % to about 5.0%.

3. The method of claim 1, wherein the hydrogenated catmint oil constitutes from about 0.10% to about 5.0% by volume.

4. The method of claim 1, wherein the hydrogenated catmint oil constitutes from about 0.10% to about 1.0% by volume.

5. The method of claim 1, wherein the hydrogenated catmint oil constitutes from about 0.05% to about 0.1% by volume.

6. The method of claim 1, wherein the emulsifying agent constitutes from about 0.01% to about 5.0% by volume.

7. The method of claim 1, wherein the emulsifying agent constitutes from about 0.10% to about 5.0% by volume.

8. The method of claim 1, wherein the emulsifying agent constitutes from about 0.10% to about 1.0% by volume.

9. The method of claim 1, wherein the emulsifying agent constitutes from about 0.05% to about 0.1% by volume.

10. The method of claim 1, wherein the formulation components constitute about 0.1% of hydrogenated catmint oil, about 0.1% of emulsifying agent and about 99.8% of water, by volume.

11. The method of claim 1, wherein the at least one ultrasonic dispersion apparatus is a vaporizer.

12. The method of claim 1, wherein the rate of dispersion of the spatial formulation by each of the at least one ultrasonic dispersion apparatus is from 125 ml/hr to 250 ml/hr.

13. A method of administering an insect deterrent or repellent formulation to a human or animal host, comprising:
obtaining formulation components, comprising:
from about 0.001% to about 5.0% of hydrogenated catmint oil;
from 0.001% to about 5.0% of an emulsifying agent; and
a remainder of water by volume;
combining the hydrogenated catmint oil, emulsifying agent and water to form a spatial formulation;
obtaining at least one ultrasonic dispersion apparatus;
placing the spatial formulation in the apparatus;
setting the apparatus in proximity of the host; and
activating the apparatus to disperse the spatial formulation into atmosphere in proximity of the host,
wherein the method excludes applying the insect deterrent or repellent formulation to the skin of the human or animal host.

14. A spatial insect deterrent or repellent formulation, comprising:
from about 0.001% to about 5.0% of hydrogenated catmint oil;
from 0.001% to about 5.0% of an emulsifying agent; and
a remainder of water by volume.
